(19) United States
(12) Patent Application Publication
(10) Pub. No.: US 2021/0247516 A1
(43) Pub. Date: Aug. 12, 2021

(54) OPTICAL NAVIGATION APPARATUS

(71) Applicant: VISUAL SENSING TECHNOLOGY CO., LTD., Hsinchu City (TW)

(72) Inventor: Chih-Yen Wu, Hsinchu City (TW)

(73) Assignee: VISUAL SENSING TECHNOLOGY CO., LTD., Hsinchu City (TW)

(21) Appl. No.: 16/923,111

(22) Filed: Jul. 8, 2020

Related U.S. Application Data
(60) Provisional application No. 62/972,652, filed on Feb. 11, 2020.

(30) Foreign Application Priority Data
May 7, 2020 (TW) 109115162

(51) Int. Cl. G01S 17/58; G06T 7/20; G01S 17/88

(52) U.S. Cl. CPC G01S 17/58; G06T 2207/30241; G01S 17/88; G06T 7/20

(57) ABSTRACT

An optical navigation apparatus including a plurality of light sources, a sensing element, and a control circuit is provided. The plurality of light sources are configured to emit a plurality of light beams onto a surface under measurement, and the plurality of light beams are incident on different positions of the surface under measurement to form a plurality of areas under measurement. The sensing element is configured to receive a plurality of reflected light beams after the plurality of light beams are reflected by the surface under measurement. The control circuit is electrically connected to the plurality of light sources and the sensing element. Each of the plurality of reflected light beams forms a sensing image. The control circuit calculates a movement trajectory of the optical navigation apparatus through a correlation of the plurality of sensing images over a plurality of different times.

### CROSS-REFERENCE TO RELATED APPLICATION

This application claims the priority benefits of U.S. provisional application Ser. No. 62/972,652, filed on Feb. 11, 2020, and Taiwan application serial no. 109115162, filed on May 7, 2020. The entirety of each of the above-mentioned patent applications is hereby incorporated by reference herein and made a part of this specification.

### BACKGROUND

### Technical Field

The disclosure relates to an apparatus, and more particularly, to an optical navigation apparatus.

### Description of Related Art

It has been more than 20 years since the development of robotic vacuum cleaners in 1996, but not until recently do the robotic vacuum cleaners begin to gain consumers' attention thanks to the breakthroughs in software and hardware technologies. Two indicators are mainly used to evaluate performance of a robotic vacuum cleaner, one is the cleaning rate, and the other one is the coverage rate. The cleaning effect depends on a hardware structure design of a robot body, and the degree of coverage depends on a software algorithm and a navigation technology. In other words, the cleaning rate indicates the cleaning effect, the coverage rate represents the cleaning efficiency of the robotic vacuum cleaner, and both are indispensable. Therefore, a technology to be urgently enhanced and improved by manufacturers at present is to improve the cleaning efficiency by performing path calculation and evaluation through different navigation technologies.

Furthermore, the navigation technologies are divided into passive navigation and active navigation. The passive navigation usually uses simple collision feedback and uses mechanical roller movement to achieve distance and endpoint measurement, thereby achieving trajectory detection. However, the collision mode is likely to cause damage to furniture, and the roller movement is susceptible to false judgments such as actually not moving due to object obstacles.

The active navigation is also divided into three types: inertial navigation, visual simultaneous localization and mapping (vSLAM), and laser direct structuring SLAM (LDS SLAM). In the inertial navigation, an inertial sensor uses a gyroscope and an accelerometer to obtain angular and linear acceleration information of the robotic vacuum cleaner and to obtain position information of the robotic vacuum cleaner through integration. But accuracy may be affected by gyroscope drift, calibration errors, sensitivity, and other problems. Moreover, with accumulated errors such as the continuous increase of travel time and distance, the errors also continue to increase.

In the vSLAM, images of the environment are obtained by a camera, and differences between the images are used to calculate position information of the robotic vacuum cleaner. However, such positioning manner is considerably affected by illumination conditions, and requirements for algorithms of complex scenes are high. Since the camera is used to complete positioning, the robotic vacuum cleaner may be directly disorientated when being used in an excessively bright or dark room, and considerable costs are also required.

In the LDS SLAM, a room is scanned with a laser ranging sensor to quickly acquire distance information. When the laser is projected on an obstacle, a light spot is formed, and meanwhile, an image sensor calculates a center distance to the laser ranging sensor according to a pixel number of the light spot. However, the costs of LDS SLAM are high, and the accuracy of correction is closely related to the detection of distance, so that this type of navigation may not be widely applied easily.

### SUMMARY

The disclosure provides an optical navigation apparatus capable of providing a positioning result with high accuracy and requiring low costs.

An optical navigation apparatus according to an embodiment of the disclosure includes a plurality of light sources, a sensing element, and a control circuit. The plurality of light sources are configured to emit a plurality of light beams onto a surface under measurement. The plurality of light beams are incident on different positions of the surface under measurement to form a plurality of areas under measurement. The sensing element is configured to receive a plurality of reflected light beams after the plurality of light beams are reflected by the surface under measurement. The control circuit is electrically connected to the plurality of light sources and the sensing element. Each of the plurality of reflected light beams forms a sensing image. The control circuit calculates a movement trajectory of the optical navigation apparatus through a correlation of the plurality of sensing images over a plurality of different times.

In an embodiment of the disclosure, the control circuit controls the plurality of light sources to sequentially emit the plurality of light beams such that the sensing element sequentially senses the plurality of sensing images generated by the plurality of light beams respectively and calculates a movement angle of the optical navigation apparatus through a positional difference of the plurality of sensing images over the plurality of different times respectively.

In an embodiment of the disclosure, the sensing element and the control circuit are integrated on a same chip.

In an embodiment of the disclosure, the sensing element and the control circuit belong to two different chips.

In an embodiment of the disclosure, the sensing element includes a plurality of sensing pixels. The plurality of sensing pixels are arranged in an array.

In an embodiment of the disclosure, the plurality of light sources emit the plurality of light beams in a direction perpendicular to a traveling direction of the optical navigation apparatus.

In an embodiment of the disclosure, the optical navigation apparatus further includes a plurality of reflecting elements. The plurality of reflecting elements are disposed on a transmission path of the plurality of light beams from the plurality of light sources to the surface under measurement.

In an embodiment of the disclosure, the optical navigation apparatus further includes a plurality of lenses. The plurality of lenses are disposed on a transmission path of the plurality of light beams from the plurality of light sources to the plurality of reflecting elements.

In an embodiment of the disclosure, the optical navigation apparatus further includes a plurality of imaging lenses. The plurality of imaging lenses are disposed on a transmission path of the plurality of reflected light beams from the surface under measurement to the sensing element.

In an embodiment of the disclosure, an arrangement direction of the plurality of areas under measurement and a traveling direction of the optical navigation apparatus are not parallel to each other.

In an embodiment of the disclosure, an arrangement direction of the plurality of areas under measurement and a traveling direction of the optical navigation apparatus are perpendicular to each other.

In an embodiment of the disclosure, the plurality of light sources are light emitting diodes or laser diodes.

Based on the foregoing, in the optical navigation apparatus according to the embodiments of the disclosure, the optical navigation apparatus includes the plurality of light sources, and the light beams are incident on different positions of the surface under measurement to form the plurality of areas under measurement. Therefore, the optical navigation apparatus may still provide a positioning result with high accuracy under the condition of low costs.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic three-dimensional view of an optical navigation apparatus according to an embodiment of the disclosure.

FIG. 2 is a schematic cross-sectional view of the optical navigation apparatus according to an embodiment of the disclosure.

FIG. 3A to FIG. 3C illustrate different examples of movement trajectories of the optical navigation apparatus according to an embodiment of the disclosure.

### DESCRIPTION OF THE EMBODIMENTS

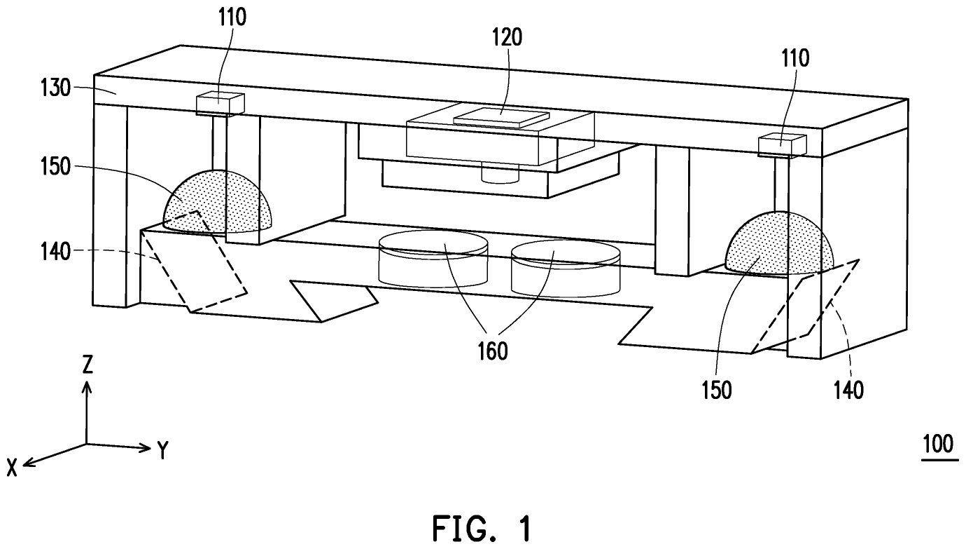

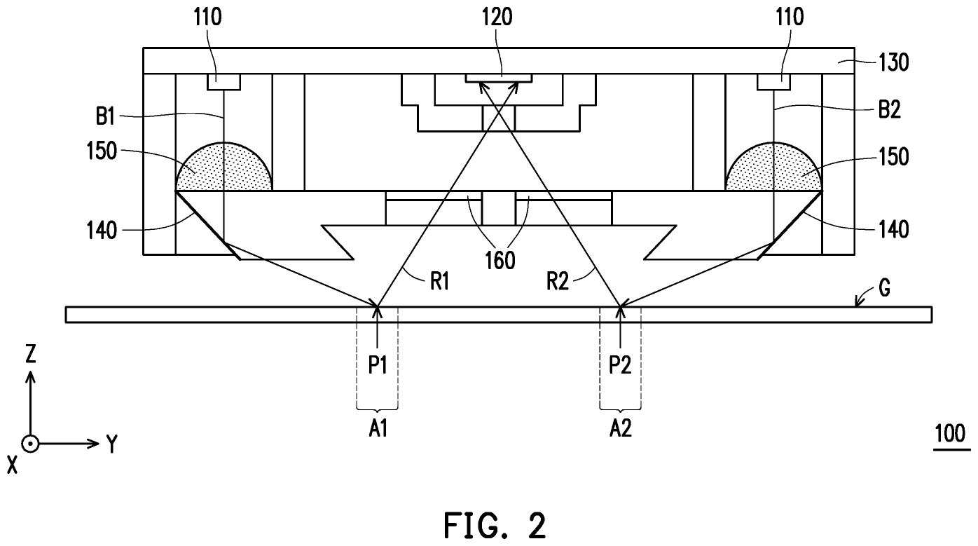

FIG. 1 is a schematic three-dimensional view of an optical navigation apparatus according to an embodiment of the disclosure. FIG. 2 is a schematic cross-sectional view of the optical navigation apparatus according to an embodiment of the disclosure. Referring to FIGS. 1 and 2 together, an optical navigation apparatus 100 according to an embodiment of the disclosure includes a plurality of light sources 110, a sensing element 120, and a control circuit 130. The control circuit 130 is electrically connected to the light sources 110 and the sensing element 120. In the present embodiment, the light sources 110 may be light emitting diodes or laser diodes. The sensing element 120 may be a complementary metal-oxide semiconductor (CMOS) or a charge coupled device (CCD). The sensing element 120 and the control circuit 130 are, for example, disposed on a printed circuit board (PCB). However, the light sources 110, the sensing element 120, and the control circuit 130 of the disclosure are not limited to the above. In an embodiment, the sensing element 120 and the control circuit 130 may be integrated on a same chip. In another embodiment, the sensing element 120 and the control circuit 130 belong to two different chips.

For convenience of description, two light sources 110 are illustrated in FIGS. 1 and 2. A surface under measurement G in FIG. 2 is, for example, a floor or a ceiling. In the present embodiment, the plurality of light sources 110 are configured to emit a plurality of light beams B1 and B2 onto the surface under measurement G. The light beams B1 and B2 are incident on different positions P1 and P2 of the surface under measurement G to form a plurality of areas under measurement A1 and A2. In detail, the light beams B1 and B2 are incident on the surface under measurement G to form a plurality of light spots. Areas covered by the light spots may be the areas under measurement A1 and A2.

In the present embodiment, the sensing element 120 includes a plurality of sensing pixels. In order to enable the optical navigation apparatus 100 to effectively recognize a difference between images formed by each of the light beams B1 and B2 in each of the areas under measurement A1 and A2, for example, the degree of change with time regarding the positions of the light spots in each of the areas under measurement A1 and A2, the sensing pixels may be an m×l, l×m, m×n, n×m, or m×m array structure, where m and n are positive integers greater than or equal to 2.

Furthermore, in the present embodiment, the sensing element 120 is configured to receive a plurality of reflected light beams R1 and R2 after the light beams B1 and B2 are reflected by the surface under measurement G. Each of the reflected light beams R1 and R2 forms a sensing image. The control circuit 130 calculates a movement trajectory of the optical navigation apparatus 100 through a correlation of the sensing images over a plurality of different times.

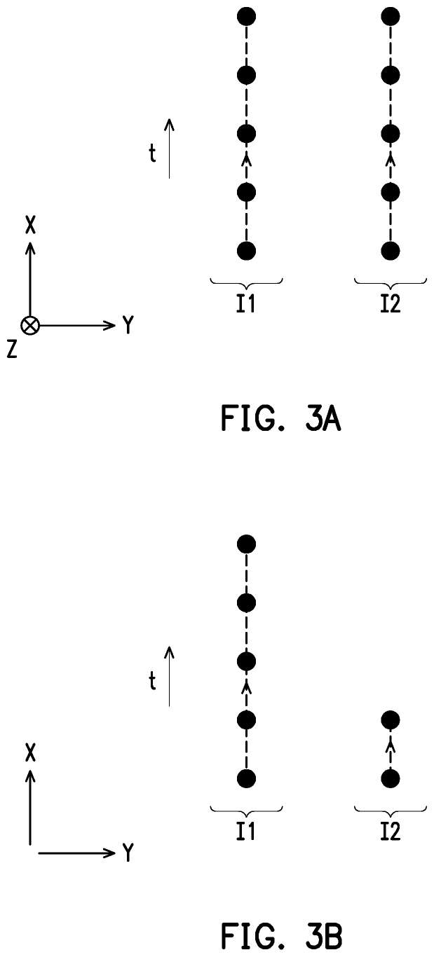

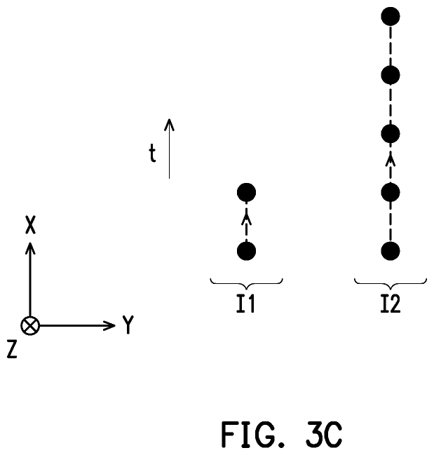

For example, FIG. 3A to FIG. 3C illustrate different examples of movement trajectories of the optical navigation apparatus according to an embodiment of the disclosure. In FIG. 3A to FIG. 3C, each light spot indicates a sensing image at a time point, an X direction is a straight traveling direction, and a Y direction is a right traveling direction. Sensing images I1 and I2 are, for example, images formed by the reflected light beams R1 and R2, respectively. For convenience of description, the reflected light beam R1 corresponds to a first light source 110 and a first light beam B1, and the reflected light beam R2 corresponds to a second light source 110 and a second light beam B2. For convenience of illustration, FIG. 3A to FIG. 3C show the sensing images I1 and I2 over different times in the same graph. For example, in FIG. 3A, the first light source 110 emits the first light beam B1 over a first time, and the sensing element 120 obtains the sensing image I1. The second light source 110 emits the second light beam B2 over a second time, and the sensing element 120 obtains the sensing image I2. Then, the first light source 110 emits the first light beam B1 over a third time, and the sensing element 120 obtains the sensing image I1. The second light source 110 emits the second light beam B2 over a fourth time, and the sensing element 120 obtains the sensing image I2. By analogy, the plurality of light sources 110 alternately emit the plurality of light beams B1 and B2, so that the sensing element obtains the plurality of sensing images I1 and I2 over different times. Furthermore, the control circuit 130 analyzes a correlation between the sensing images I1 over a plurality of different times and a correlation between the sensing images I2 over a plurality of different times to calculate a relative movement amount. The correlation is, for example, a difference between the positions of light spots in the sensing images I1 and I2 over different times. For example, the difference between the sensing image I1 obtained over the first time and the sensing image I1 obtained over the third time is analyzed to calculate a movement amount of the optical navigation apparatus 100 relative to the area under measurement A1, and the difference between the sensing image I2 obtained over the second time and the sensing image I2 obtained over the fourth time is analyzed to calculate a movement amount of the optical navigation apparatus 100 relative to the area under measurement A2. Then, the foregoing correlation between the sensing images I1 and the foregoing correlation between the sensing images I2 is applied to calculate a movement angle of the optical navigation apparatus 100. That is, a movement angle of the optical navigation apparatus 100 is calculated according to the movement amount of the optical navigation apparatus 100 relative to the area under measurement A1 and the movement amount of the optical navigation apparatus 100 relative to the area under measurement A2. In FIG. 3A, since a relative movement amount between the sensing images I1 is the same as a relative movement amount between the sensing images I2, the control circuit 130 may calculate that a movement trajectory of the optical navigation apparatus 100 is straight traveling.

By analogy, in FIG. 3B, the relative movement amount between the sensing images I2 is significantly less than the relative movement amount between the sensing images I1. Therefore, the control circuit 130 may calculate that the movement trajectory of the optical navigation apparatus 100 is right traveling (that is, right turn). Similarly, according to FIG. 3C, the control circuit 130 may calculate that the movement trajectory of the optical navigation apparatus 100 is left traveling (that is, left turn). That is to say, in the present embodiment, the control circuit 130 may control the light sources 110 to sequentially emit the light beams B1 and B2, so that the sensing element 120 sequentially senses the sensing images I1 and I2 generated by the light beams B1 and B2 respectively and calculates the movement angle of the optical navigation apparatus 100 through the positional difference of the sensing images I1 and I2 over a plurality of different times respectively.

Based on the foregoing, in the optical navigation apparatus 100 according to the embodiments of the disclosure, since the optical navigation apparatus 100 includes a plurality of light sources 110, and light beams B1 and B2 are incident on different positions P1 and P2 of the surface under measurement G to form the plurality of areas under measurement A1 and A2, the optical navigation apparatus 100 may still provide a positioning result with high accuracy under the condition of low costs. Moreover, when the number of the light sources 110 increases, the accuracy of the positioning result is enhanced. Furthermore, the optical navigation apparatus 100 determines the movement trajectory of the optical navigation apparatus 100 through the correlation of the sensing images over a plurality of different times. Therefore, a misjudgment, which may occur when the optical navigation apparatus 100 does not actually move due to an object obstacle, is prevented from occurring.

In addition, when light emitting diodes or laser diodes with high directivity are selected to be used as the light sources 110 of the optical navigation apparatus 100, the control circuit 130 of the optical navigation apparatus 100 may accurately determine the correlation between the sensing images I1 and I2 formed over different times. Furthermore, the surface under measurement G may be a floor or a ceiling, so a user may select a favorable surface under measurement G according to the difference in the use environment.

In the present embodiment, the light sources 110 emit the light beams B1 and B2 in a direction perpendicular to a traveling direction of the optical navigation apparatus 100. The straight traveling direction is, for example, an X-axis direction, and the light sources 110 emit the light beams B1 and B2, for example, in a Z-axis direction. Furthermore, the optical navigation apparatus 100 further includes a plurality of reflecting elements 140. The reflecting elements 140 are disposed on a transmission path of the light beams B1 and B2 from the light sources 110 to the surface under measurement G.

In an embodiment, the light sources 110 may directly make the light beams B1 and B2 incident onto positions P1 and P2 of the surface under measurement G without the reflecting elements.

In an embodiment, the optical navigation apparatus 100 further includes a plurality of lenses 150. The lenses 150 are disposed on a transmission path of the light beams B1 and B2 from the light sources 110 to the reflecting elements 140, so that the light beams B1 and B2 are collimated or the light beams B1 and B2 are focused on the surface under measurement G. Therefore, a signal-to-noise ratio of the sensing images I1 and I2 obtained by the optical navigation apparatus 100 may be improved, so that an accurate positioning result is obtained.

In an embodiment, the optical navigation apparatus 100 further includes a plurality of imaging lenses 160. The imaging lenses 160 are disposed on a transmission path of the reflected light beams R1 and R2 from the surface under measurement G to the sensing element 120. The sensing images I1 and I2 may also be accurately recognized through the arrangement of the imaging lenses 160, so that an accurate positioning result is obtained.

The optical navigation apparatus 100 may determine the correlation between the sensing images I1 and I2 formed over different times, and moreover, in the present embodiment, an arrangement direction of the areas under measurement A1 and A2 and a traveling direction of the optical navigation apparatus 100 may be arrange not to be parallel to each other, and the arrangement direction of the plurality of areas under measurement A1 and A2 and the traveling direction of the optical navigation apparatus 100 are preferably perpendicular to each other. For example, the arrangement direction of the areas under measurement A1 and A2 is a Y-axis direction, and the traveling direction of the optical navigation apparatus 100 is an X-axis direction.

Based on the foregoing, in the optical navigation apparatus according to the embodiments of the disclosure, since the optical navigation apparatus includes the plurality of light sources, and the light beams are incident on different positions of the surface under measurement to form the plurality of areas under measurement, the optical navigation apparatus may still provide a positioning result with high accuracy under the condition of low costs. Moreover, when the number of the light sources increases, enhanced accuracy of the positioning result is provided. Furthermore, the optical navigation apparatus determines the movement trajectory of the optical navigation apparatus through the correlation of the sensing images over a plurality of different times. Therefore, a misjudgment, which may occur when the optical navigation apparatus does not actually move due to an object obstacle, is prevented from occurring.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical navigation apparatus, comprising:
a plurality of light sources, configured to emit a plurality of light beams onto a surface under measurement, wherein the plurality of light beams are incident on different positions of the surface under measurement to form a plurality of areas under measurement;
a sensing element, configured to receive a plurality of reflected light beams after the plurality of light beams are reflected by the surface under measurement; and
a control circuit, electrically connected to the plurality of light sources and the sensing element, wherein each of the plurality of reflected light beams forms a sensing image and the control circuit calculates a movement trajectory of the optical navigation apparatus through a correlation of the plurality of sensing images over a plurality of different times.

2. The optical navigation apparatus according to claim 1, wherein the control circuit controls the plurality of light sources to sequentially emit the plurality of light beams such that the sensing element sequentially senses the plurality of sensing images generated by the plurality of light beams respectively and calculates a movement angle of the optical navigation apparatus through a positional difference of the plurality of sensing images over the plurality of different times respectively.

3. The optical navigation apparatus according to claim 1, wherein the sensing element and the control circuit are integrated on a same chip.

4. The optical navigation apparatus according to claim 1, wherein the sensing element and the control circuit belong to two different chips.

5. The optical navigation apparatus according to claim 1, wherein the sensing element comprises a plurality of sensing pixels, and the plurality of sensing pixels are arranged in an array.

6. The optical navigation apparatus according to claim 1, wherein the plurality of light sources emit the plurality of light beams in a direction perpendicular to a traveling direction of the optical navigation apparatus.

7. The optical navigation apparatus according to claim 1, further comprising:
a plurality of reflecting elements, disposed on a transmission path of the plurality of light beams from the plurality of light sources to the surface under measurement.

8. The optical navigation apparatus according to claim 7, further comprising:
a plurality of lenses, disposed on a transmission path of the plurality of light beams from the plurality of light sources to the plurality of reflecting elements.

9. The optical navigation apparatus according to claim 1, further comprising:
a plurality of imaging lenses, disposed on a transmission path of the plurality of reflected light beams from the surface under measurement to the sensing element.

10. The optical navigation apparatus according to claim 1, wherein an arrangement direction of the plurality of areas under measurement and a traveling direction of the optical navigation apparatus are not parallel to each other.

11. The optical navigation apparatus according to claim 1, wherein an arrangement direction of the plurality of areas under measurement and a traveling direction of the optical navigation apparatus are perpendicular to each other.

12. The optical navigation apparatus according to claim 1, wherein the plurality of light sources are light emitting diodes or laser diodes.
